(19) United States
(12) Patent Application Publication
(10) Pub. No.: US 2026/0047549 A1
(43) Pub. Date: Feb. 19, 2026

(54) AUTOMATIC PET WATERING SYSTEM

(71) Applicant: Law Office of Jerry Joseph, PLC, Washington, DC (US)

(72) Inventors: Steve Booher, Carmel, IN (US); Gary A. Vandenbark, Greenfield, IN (US); Gary Shaw, Columbus, IN (US)

(21) Appl. No.: 18/805,519

(22) Filed: Aug. 14, 2024

(51) Int. Cl. A01K 7/02

(52) U.S. Cl. CPC A01K 7/02

(57) ABSTRACT

An automatic pet watering system including a base housing configured to support various components, a water bowl configured to fit into the base housing, a water pump configured for recirculating the water held in the main bowl, a bowl controller configured to periodically operate the water pump on a predetermined schedule, and a spray nozzle affixed to the pump outlet tube and projecting through the boss at the upper edge of the concave circular bowl surface, the spray nozzle configured to project water from the pump outlet tube laterally from the pump outlet tube at an angle and orientation predetermined to cause a vortex effect in the water in the water bowl when the water pump is operating.

### BACKGROUND OF THE INVENTION

### 1. Field of the Invention

The present general inventive concept relates to automatic pet watering systems, and more particularly, to an automatic pet watering system having a continuous water filtering system using a vortex generating nozzle and a water filtration system.

### 2. Description of Related Art

Clean water is the single most important nutrient in an animal body. It is essential for all metabolic processes, chemical reactions, temperature regulation, eliminating waste from the body and, ultimately, health and survival. Even a small amount of contaminated water can cause pets to develop various types of illnesses and infections.

There have been previous pet water bowl devices that automatically refill the water bowl with water. However, these devices tend to collect a large amount of debris such as dirt, bugs, pet hair and food, thereby contaminating the water.

Therefore, what is desired is an automatic pet watering system that completely flushes all types of debris and contaminations from a water bowl and provide pets with a continuous source of clean uncontaminated fresh water.

### BRIEF SUMMARY OF INVENTION

The present general inventive concept provides an automated system to provide fresh and clean water for pets. It incorporates a flush and filter design that collects debris, which can then be easily disposed of in a sanitary way, and an optional associated application that permits a user to monitor the system, including monitoring the amount of water being consumed.

The present general inventive concept also provides an automated system that provides fresh and clean water for pets and monitors various aspects of the system including whether the water bowl is tilted, whether the controller has been removed, whether the water bowl has failed to fill with water, whether the flush pump has no contact, a water level within the water bowl, when to replace wall unit filter, when to replace wall bowl filter, and normal operation status of the system.

The present general inventive concept also provides an automated system that provides fresh and clean water for pets and monitors amount of water intake by each pet, changes to the daily intake amount. In addition, the present general inventive concept also provides an automated system that provides alerts for water bowl software updates and other alerts as necessary to maintain proper operation of the automated system.

In an exemplary embodiment, the automated system according to the present general inventive concept uses a laser system to detect current water level in the water bowl, in order to maintain consistent water level in the water bowl, relieving a user of having to monitor water level and re-fill as needed. Because water level is automatically maintained, there is no need for a drain since the water bowl will not overfill because of this water level detection capability and because the automated system has three times redundancy to prevent overfill.

The present invention further includes an external water source to ensure that the water bowl has a constant level of fresh water as consumed by one or more pets.

An automatic flush system, using a water pump that recirculates water in the water bowl, periodically (for example, each hour) sucks the water in the water bowl through a filter system in a manner that flushes debris such as food, bugs, dirt, hair, etc., from the water bowl so that the debris can then be selectively extracted by the user. This filter system includes a cotton or charcoal/cotton filter fitted inside an 80 mesh stainless-steel basket in the bowl to collect and hold debris until extracted by the pet owner. The pet owner can periodically remove and dispose of the collected debris by removing the filter and replacing it with a new filter.

In an exemplary embodiment, an optional application is associated with the system to provide historical and daily use reports and optional notifications for water intake, filter changes, etc. Additional features available with the application permit a user to make unique settings to modify the default settings for parameters such as water depth, bowl-flush frequency, etc. Since the basic automatic watering system described herein operates independent of this app, this application is totally optional and is not at all a necessary component in the basic operation of the automatic pet watering system of the present invention. However, without the application, the user would not get notifications or daily pet intake data.

The present general inventive concept provides an automatic pet watering system that automatically and periodically flushes all types of debris from water in the water bowl through a filter system using a water pump and a specially designed vortex generation system to wash and capture the debris.

In the present embodiment, the vortex generation system uses a water pump and a specifically designed nozzle to create a vortex of water within the water bowl to force any debris floating in the water or adhered to the water bowl to be swept downward into the filter system. The debris is then passed through and captured by the filter system. A user may then remove the captured debris by replacing the filter within the filter system.

In the present embodiment, the automatic pet watering system further includes a water level detection system that is designed and configured to monitor a water level in the water bowl. As such, the automatic pet watering system is able to maintain a desired water level within the water bowl at all times. That is, the user may first set a desired water level within the water bowl. As the pet consumes the water, the water level detection system will output a signal to the water pump thorough a controller to replenish water within the water to the desired water level.

In alternative embodiments, the automatic pet watering system further includes a mobile application or software application, which allows the user to remotely control the desired water level within the water bowl, monitor an amount of water the pet consumers per day, and a condition of the water filter. However, the present general inventive concept is not limited thereto.

That is, in alternative embodiments, the software application may communicate directly and/or indirectly to a user's mobile device to provide a number of additional features and benefits, such as allowing a user to set and check parameters and conditions of the automatic watering system, including the amount of water consumed by the pet, lighting of the water bowl, activation of two-way audio and/or visual communication between the automatic pet watering system and the user's mobile device.

Features and/or utilities of the present general inventive concept may be achieved by providing an automatic pet watering system including a base housing configured to support various components of the automatic pet watering system, a water bowl configured to fit into the base housing and configured to have a circular shape from a top view, a diameter of the circular shape decreasing so as to form a concave circular bowl surface for holding water, the concave circular bowl surface culminating in a circular opening forming a tube-shaped portion at a bottom of the main bowl, the concave circular bowl surface configured with a boss (i.e., a raised stud) and opening near an upper edge of the concave circular bowl surface, the tube-shaped portion having first and second openings near a bottom edge of the tube-shaped portion, a water pump configured for recirculating the water held in the main bowl, wherein the water pump is configured as connected a pump outlet tube having a distal end that projects through the opening of the boss at the upper edge of the concave circular bowl surface and is configured as connected to a pump inlet tube having a distal end affixed to the first opening at the bottom edge of the tube-shaped portion, a bowl controller configured to periodically operate the water pump on a predetermined schedule; and a spray nozzle affixed to a distal end of the pump outlet tube and projecting through the boss at the upper edge of the concave circular bowl surface, the spray nozzle configured to project water from the pump outlet tube laterally from the pump outlet tube at an angle and orientation predetermined to cause a vortex effect in the water in the water bowl when the water pump is operating.

The automatic pet watering system may further include a filter system fitted inside the tube-shaped portion at the bottom of the main bowl.

A top section of the filter system may include a bowl insert having a top surface shaped to form a bottom surface of the water bowl and having a bottom surface shaped with a snout and baffles that prevent floating debris from reentering the water bowl when the water pump is no longer operating to recirculate water in the main bowl.

The filter system may include a debris storage section that holds debris sucked into the filter system as the water in the water bowl is recirculated. The debris storage section may include a cotton or charcoal/cotton filter to capture debris sucked through the filter system by a vortex formed by the water pump and vortex generating nozzle.

The filter may be supported by a mesh stainless steel filter cage.

A user may selectively access the debris storage section to expose and discard collected debris and exchange the cotton or charcoal/cotton filter with a new filter element.

The automatic pet watering system may further include a splash guard ring affixed to a top edge of the main bowl.

The base housing may be configured with a box-shaped portion with one end open to face an interior of the automatic pet watering system.

The automatic pet watering system may further include a lid portion configured to cover the box-shaped portion, the lid portion may be configured with a water dish input tube to be selectively attached to a water input tube structure connected to a water source providing fresh input water to the automatic pet watering system, wherein the water input tube structure includes a water tube for carrying water from the water source to the automatic pet watering system, a power line to provide electrical power to the recirculating motor and pump controller in the automatic pet watering system, and a signal line to permit control signals between the pump control unit bowl controller in the automatic pet watering system and a controller located at the water source providing fresh water to the automatic pet watering system, and wherein the water tube, power line, and signal line are protected from damage by pets by being enclosed in a stainless steel braiding.

The power line may provide 12 VDC power to the water pump used to recirculate water in the main bowl. However, the present general inventive concept is not limited thereto. The power line and signal line may include a conventional USB standard connector cable.

The signal line in the USB standard connector cable may provide data for an application that is optionally associated with the automatic pet watering system for providing a user with information related to the automatic pet watering system. Any data collected from the system may be transmitted using Wi-Fi and/or various other wireless communication protocols.

The application may be selectively used by a user to remotely change any of the predetermined system setting values. In an embodiment, the user can change the water depth within the water bowl and control the flush cycle using the application. However, the present general inventive concept is not limited thereto.

The lid portion covering the box-shaped portion may be configured with at least one LED controlled by the pump control unit in the automatic pet watering system to indicate to a user a plurality of advisory conditions related to the automatic pet watering system.

The automatic pet watering system may further include a sensor that senses a level of water in the water bowl and provides water level information to the pump bowl controller, the pump bowl controller transmitting a control signal to a water source providing fresh water to the automatic pet watering system when the pump bowl controller determines that the water level has fallen below a predetermined amount.

The sensor that senses the water level includes a Time of Flight (ToF) sensor using an infrared sensor and/or a laser sensor.

The automatic pet watering system may further include a solenoid-based fresh water module configured to be connected to a pressurized water source and configured with a solenoid controller to control one or more solenoids in the solenoid-based fresh water module, the solenoid-based fresh water module may be configured with an output connected to the water input tube structure of the automatic pet watering system, the solenoid controller configured to receive signals on the signal line of the water input tube structure to control providing fresh water to the automatic pet watering system under control signals sent by the pump bowl controller in the automatic pet watering system.

The automatic pet watering system may further include a pump-based fresh water module configured to be connected to a container storing fresh water available to be provided as fresh water to the automatic pet watering system upon demand from the pump bowl controller of the automatic pet watering system, the pump-based fresh water module configured with an output connected to the water input tube structure of the automatic pet watering system, the pump-based fresh water module configured with a fresh water pump and a fresh water pump controller, the fresh water pump controller configured to receive signals from the control unit in the water base on the signal line of the water input tube structure to control pumping fresh water to the automatic pet watering system under control signals sent by the pump bowl controller in the automatic pet watering system.

Features and/or utilities of the present general inventive concept may be achieved by also providing a pump-based fresh water module configured to be connected to a container of water to be supplied as fresh water to an automatic pet watering system, the pump-based fresh water module includes a pump configured to pump water from the container of fresh water into an output water tube that provides fresh water to the automatic pet watering system, a pump controller configured to control the pump that provides water from the container of fresh water to the automatic pet watering system, the pump controller configured to be under control signals from a control unit in the automatic pet watering system, a power source that provides electrical power to the pump-based fresh water module and an output port configured to fit to a water tube structure to be connected between the automatic pet waterer system and the output port of the pump-based fresh water module, the water tube structure including a water tube for conducting fresh water from the container of fresh water to the automated pet waterer system, a signal line for conducting control signals between the controller in the automatic pet watering system and the pump controller in the pump-based fresh water module and a power line to conduct electrical power to the automatic pet watering system via the pump-based fresh water module.

Features and/or utilities of the present general inventive concept may be achieved by also providing a solenoid-based fresh water module configured to be connected to a pressurized water line for providing fresh water to an automatic pet watering system, the solenoid-based fresh water module including at least one solenoid configured permit a flow of water from the pressurized water line into an output water tube that provides fresh water from the pressurized water line to the automatic pet watering system, a solenoid controller configured to control the at least one solenoid, the solenoid controller configured to be under control signals from a controller in the automatic pet watering system, a power source that provides electrical power to the solenoid-based fresh water module, and an output port configured to fit to a water tube structure to be connected between the automatic pet waterer system and the output port of the solenoid-based fresh water module, the water tube structure including a water tube for conducting fresh water from the container of fresh water to the automatic pet watering system, a signal line for conducting control signals between the controller in the automated pet waterer system and the pump controller in the solenoid-based fresh water module; and a power line to conduct electrical power to the automatic pet watering system via the pump-based fresh water module.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a front perspective view of an automatic pet watering system according to an embodiment of the present inventive concept;

FIG. 2 illustrates a rear perspective view of the automatic pet watering system illustrated in FIG. 1;

FIG. 3 shows an exploded front perspective assembly view of the automatic pet watering system illustrated in FIG. 1;

FIG. 4 shows an exploded rear perspective assembly view of the automatic pet watering system illustrated in FIG. 1;

FIG. 5 shows a schematic diagram of a power supply, a bowl control unit, and a water pump of the automatic pet watering system illustrated in FIG. 1;

FIG. 6 is a front perspective view of the water bowl illustrated in FIG. 3;

FIG. 7 is a front view of the water bowl illustrated in FIG. 6;

FIG. 8 is a top plan view of the water bowl illustrated in FIG. 6;

FIG. 9 shows a longitudinal cross-sectional view at a mid-section of the automatic pet watering system illustrated in FIG. 1;

FIG. 10 shows a front perspective assembly view of an automatic pet watering system according to another embodiment of the present general inventive concept;

FIG. 10A shows a cross-sectional view of the integrated cable illustrated in FIG. 10, along line A-A;

FIG. 11 shows a front perspective view the pump/controller assembly illustrated in FIG. 10 according to an embodiment of the present general inventive concept;

FIG. 11A shows an exploded assembly view of the pump/controller assembly illustrated in FIG. 11.

FIG. 12 shows a front perspective assembly view of an automatic pet watering system according to another embodiment of the present general inventive concept;

FIG. 13 shows a front perspective view of the solenoid based control module illustrated in FIG. 12;

FIG. 13A shows an exploded assembly view of the solenoid based control module illustrated in FIG. 13.

### DETAILED DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The present general inventive concept provides a novel and convenient system and method for providing and maintaining consistent clean and uncontaminated water for a user's pet or pets, including a capability of automatically extracting both immersed and floating debris commonly associated with conventional pet water bowls.

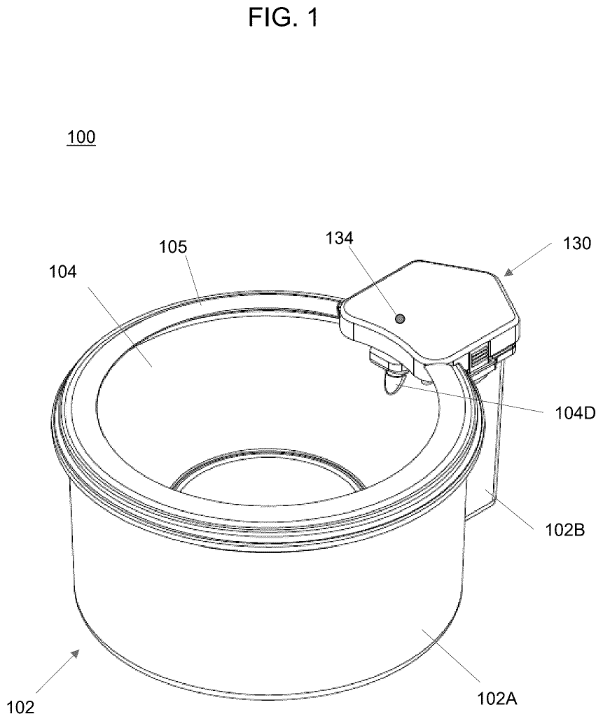

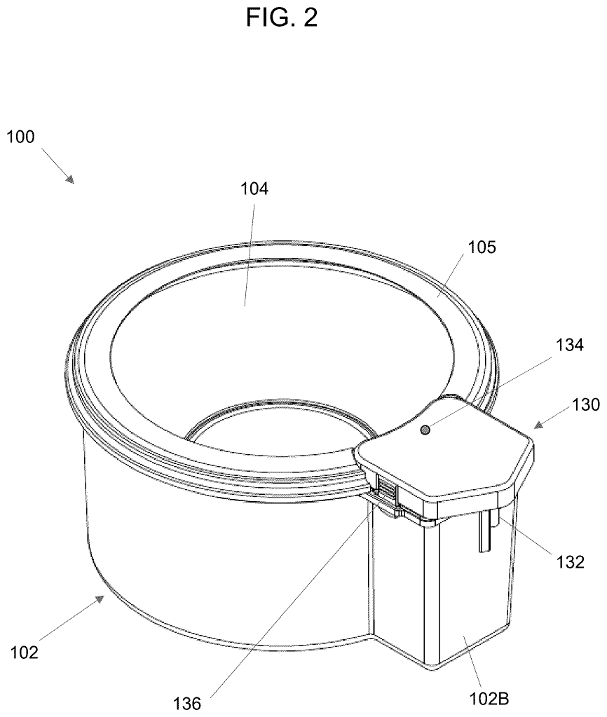

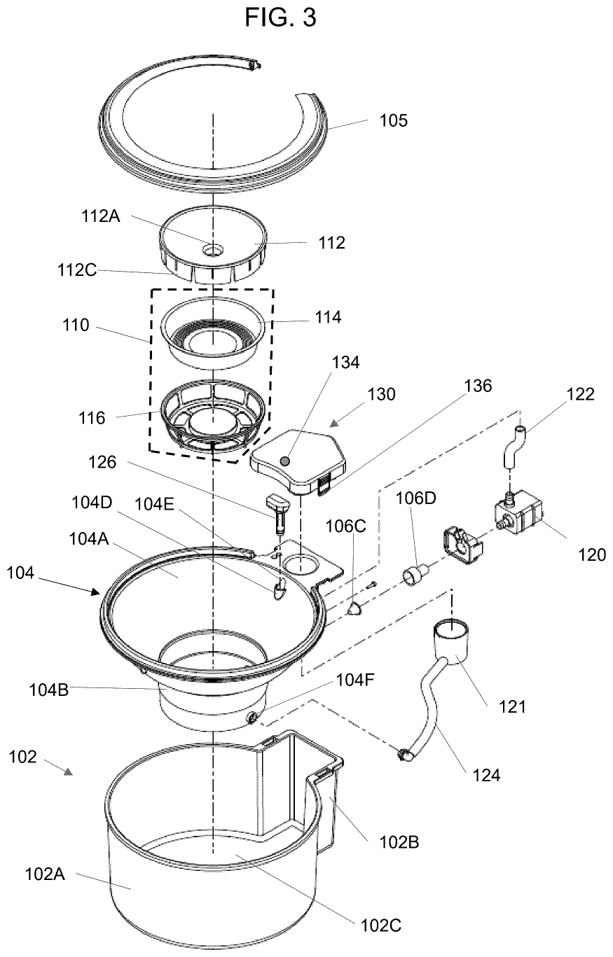

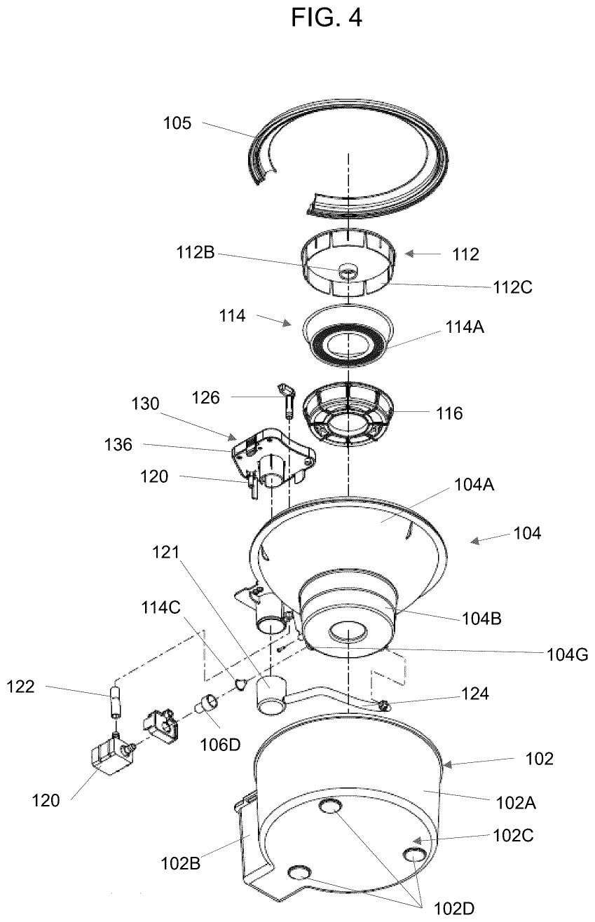

FIG. 1 is a front perspective view of an automatic pet watering system 100 according to an embodiment of the present inventive concept and FIG. 2 illustrates a rear perspective view of the automatic pet watering system 100 illustrated in FIG. 1. FIG. 3 shows an exploded front perspective assembly view of the automatic pet watering system illustrated in FIG. 1 and FIG. 4 shows an exploded rear perspective assembly view of the automatic pet watering system illustrated in FIG. 1.

Referring to FIGS. 1 through 4, the automatic pet watering system, designated generally as 100, is illustrated.

The automatic pet watering system 100 according to the present general inventive concept includes a base housing 102 designed to support the water bowl 104, a filter system 110, a bowl control unit 130 (e.g., a controller), and a water pump 120 that automatically circulates water from the water bowl 104 through the filter system 110 and then back into the water bowl 104.

That is, in the present embodiment, the automatic pet watering system 100 is designed and configured to automatically and periodically remove all debris and contaminations from water stored in the water bowl 104. The automatic pet watering system 100 is also designed and configured to maintain the water in the water bowl 104 to a desired level, as defined by a user.

### Base Housing

In the present embodiment, the base housing 102 includes a partially cylindrical portion 102A designed to receive the water bowl 104, a partially rectangular portion 102B designed to receive and enclose the water pump 120, and a bottom portion 102C designed to receive and support the filter system 110.

Referring to FIG. 3, the cylindrical portion 102A of the base housing 102 opens into a box-like portion 102B that encloses a water pump 120 and associated tubing and bowl control unit 130 used for circulating water in water bowl 104. However, the present general inventive concept is not limited thereto. That is, in alternative embodiments, the base housing 102 may be formed is various shapes to receive and enclose a water pump 120 and associated tubing and support a bowl control unit 130.

Referring to FIG. 4, the base housing 102 further includes foot pads 102D adhered to the bottom surface 102C of the base housing 102 to help prevent a pet from sliding the automatic pet watering system 100 along the floor.

### Water Bowl

Referring to FIG. 3, in the present embodiment, the water bowl 104 is configured to fit into the cylindrical portion 102A of the base housing 102 and is designed and configured to have a circular shape from a top view. A diameter of the circular shape of the water bowl 104 decreases so as to form a concave circular bowl surface 104A for holding water. However, the present general inventive concept is not limited thereto.

In an exemplary embodiment, the base housing 102 and the water bowl 104 are both molded plastic components (e.g., high density polyethylene HDPE), and the bowl base foot pads 102D are formed from silicon. However, the present general inventive concept is not limited thereto.

Although not considered limiting in any way to the invention, in the exemplary embodiment described herein, the water bowl 104 is approximately nine inches in diameter in one exemplary embodiment and approximately seven inches in diameter in another exemplary embodiment. However, the present general inventive concept is not limited thereto.

In alternative embodiments, the automatic pet watering system 100 further includes a silicon-based splash guard 105 that is ultrasonically welded to the water bowl 104 to reduce or eliminate splashing caused by the pet drinking from the water bowl 104. However, the present general inventive concept is not limited thereto.

### Filtration System

Referring to FIGS. 3 and 4, in the present embodiment, the filter system 110 includes a filter portion 114 nestled in a filter cage 116. The bowl insert 112 covers and secures the filter system 110 in place within the water bowl 104. The bowl insert 112 includes an opening 112A through which the water flows through and attachment features 112C to help secure the bowl insert 112 onto the water bowl 104.

The filter system 110 is fitted inside the tube-shaped portion 104B at the bottom of the water bowl 104. The bowl insert 112 has a top surface shaped to form a bottom surface of the water bowl 104 and a bottom surface shaped with a snout 112B that prevents floating debris from reentering the water bowl 104 when the water pump 120 is no longer operating to recirculate water in the water bowl 104.

That is, the snout 112B is a protrusion below the level of captured floating debris designed to prevent the captured floating debris from floating back into the water in the water bowl 104.

In the present embodiment, the filter element 110 is a replaceable filter element pre-shaped to fit into the underlying filter cage 116 to capture all debris sucked downward by the vortex created by the water recirculating period of the water pump 106, including not only debris that sinks in the water bowl 104 but also debris that floats in the water bowl until sucked into the filter system 110 by the vortex during the periodic water recirculating period. The material of the filter element 110 is not intended as limiting, and can include, for example, cotton or cotton/charcoal in which activated charcoal is embedded as a component of a cotton-based filter. However, the present general inventive concept is not limited thereto.

In alternative embodiments, the filter system 110 includes a debris storage section 111 that holds debris sucked into the filter system 110 as the water in the water bowl 104 is recirculated. The debris storage section includes a cotton or charcoal/cotton filter 114 to capture debris sucked through the filter system 110 by the vortex formed by the water pump 120.

In alternative embodiments, the filter 114 is supported by a mesh stainless steel filter cage 116. A user can selectively access the debris storage section to expose, and discard collected debris and exchange the cotton or charcoal/cotton filter 114 with a new filter 114 element.

Referring to FIG. 4, in exemplary embodiments, the bowl insert 112 is a molded plastic (e.g., high density polyethylene HDPE) and shaped such that debris is forced or sucked through the opening 112A and becomes trapped in the underlying cotton or cotton/charcoal filter portion 114. In the present embodiment, the filter portion 114 includes a layer of activated charcoal 114A to reduce and/or eliminate contaminates from the water.

### Bowl Control Unit

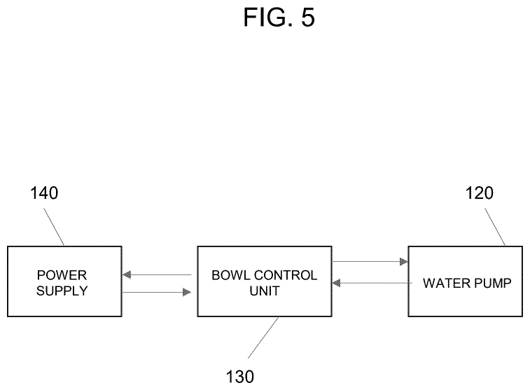

FIG. 5 shows a schematic diagram of the water pump 120, the bowl control unit 130 (i.e., controller), and the power supply 140 of the automatic pet watering system 100 illustrated in FIG. 1.

As discussed above, the bowl control unit 130 communicates with the water pump 120 and the power supply 140 to control an activation of the water pump 120. The bowl control unit 140 may be programmed and configured to periodically operate the water pump 120 on a predetermined schedule such as, for example, once every hour, thereby periodically flushing debris and contaminates such as food, bugs, dirt, hair, and any other debris from the drinking water in the water bowl 104 and capturing it in the underlying filter 114.

Other functions the bowl control unit 130 include monitoring water level based on data from the Time of Flight (ToF) sensor, detecting if the water bowl 104 is tilted, detecting if the bowl control unit 130 is removed, starting the water pump 120 to “flush”, recording amount of water is sent daily to the water bowl 104, sending signal to send more water to the water bowl 104, sending data and error messages to the Cloud (if Wi-Fi is connected), and sending error message signals to the annunciator LED 134 located on a top surface of the bowl control unit 130.

Since the bowl control unit 130 interfaces with an external water source via the water tube 122 shown in FIGS. 3 and 4, the bowl control unit 130 can be selectively detached from the water bowl 104 by operating the latch 136 shown in FIGS. 1 and 2, to permit the bowl control unit 130 to be removed, without having to remove the attached external water source.

Also mounted on a board controller (not visible in the figures) in the bowl control unit 130 is a tilt meter (not visible) that detects if the water bowl 104 is tilted over 15 degrees. This tilt information is sent as an error signal to the LED annunciator 134 and the application, if connected to Wi-Fi or any other wireless communication protocols.

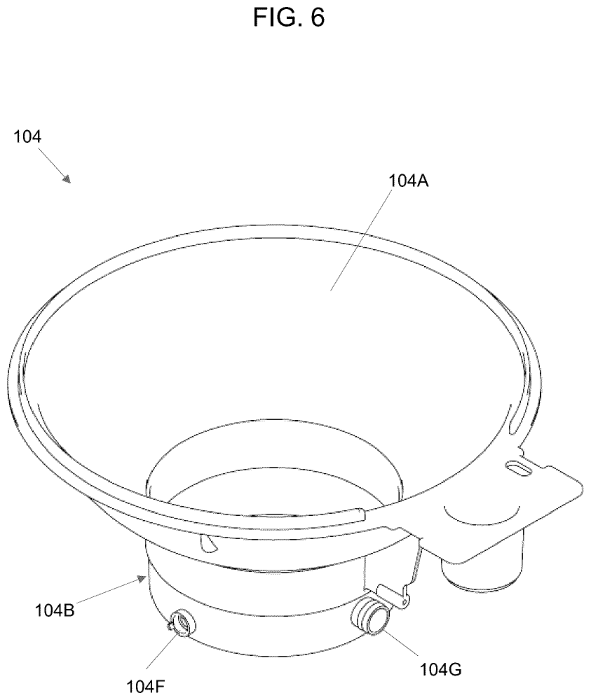

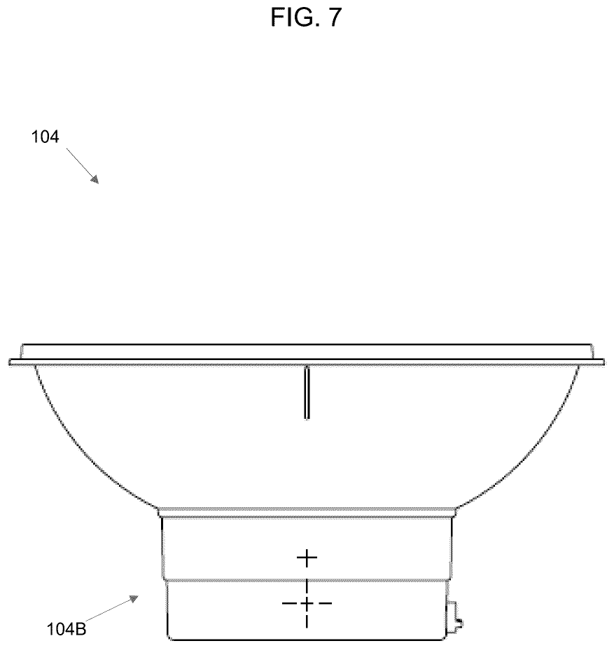

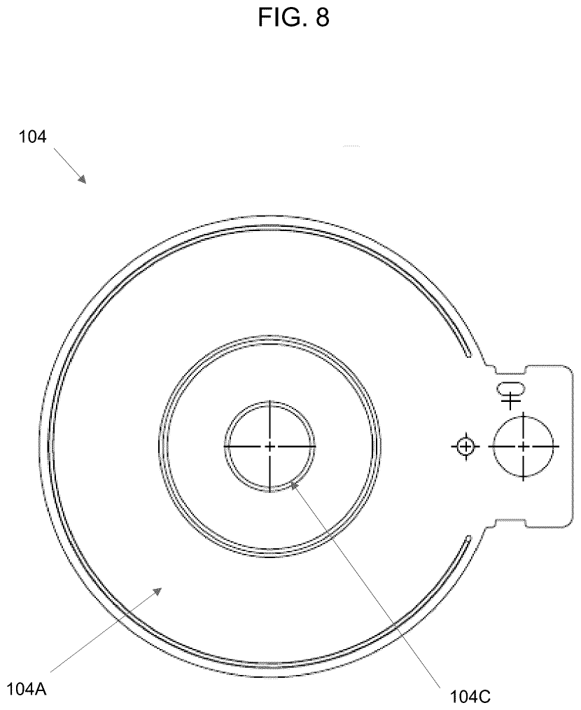

FIG. 6 is a front perspective view of the water bowl 104 illustrated in FIG. 3, FIG. 7 is a front view of the water bowl 104 illustrated in FIG. 6, and FIG. 8 is a top view of the water bowl 104 illustrated in FIG. 6.

The concave circular water bowl surface 104A culminates in a circular opening 104C forming a tube-shaped portion 104B at the bottom of the water bowl 104. The concave circular water bowl surface 104A may be configured with a boss 104D (i.e., a raised stud) and a vortex nozzle opening 104E near an upper edge of the concave circular bowl surface 104A. The tube-shaped portion 104B having first and second openings 104F, 104G near a bottom edge of the tube-shaped portion 104B of the water bowl 104.

In the present embodiment, the water pump 120 is configured for recirculating the water held in the water bowl 104. The water pump 120 is configured as being connected to a pump outlet tube 122 having a distal end that projects through the opening 104E of the boss 104D at the upper edge of the concave circular bowl surface 104A and is configured as connected to a pump inlet tube 124 having a distal end affixed to the first opening 104F at the bottom edge of the tube-shaped portion 104B.

In the present embodiment, the vortex generating nozzle 126 is affixed to a distal end of the pump outlet tube 122 and projects through the boss 104D at the upper edge of the concave circular bowl surface.

The vortex generating nozzle 126 is configured to project or dispense water from the pump outlet tube 122 laterally from the pump outlet tube 122 at an angle and orientation predetermined to cause a vortex effect in the water in the water bowl 104 when the bowl control unit 140 controls the water pump 120 to activate.

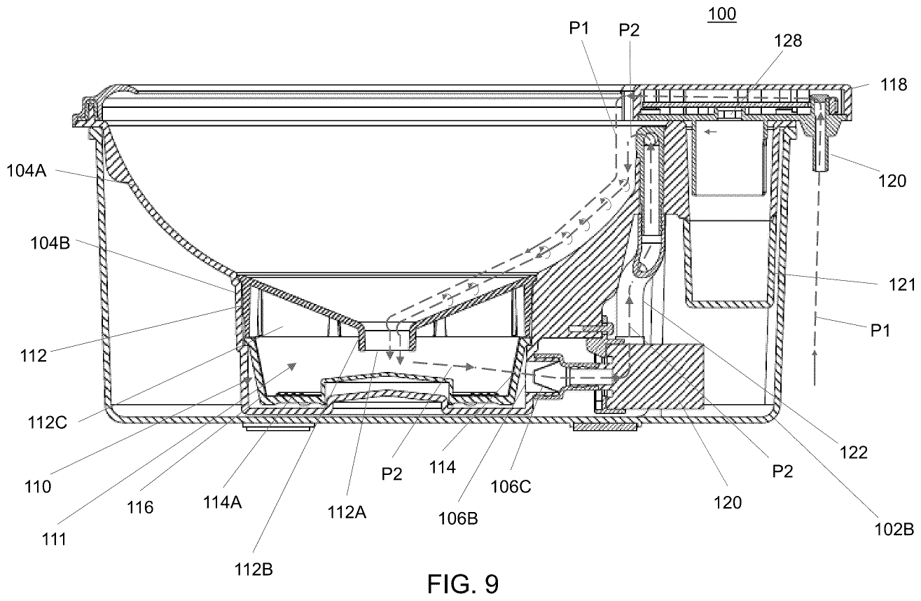

FIG. 9 shows a longitudinal cross-sectional view at the mid-section of the automatic pet watering system 100 illustrated in FIG. 1.

In the present embodiment, the automatic pet watering system 100 includes a first water channel path P1 from a water inlet 120 and ends at water outlet 104G of the water bowl 104. The water path P1 fills the water bowl 104 with water. The automatic pet watering system 100 further includes a second water channel path P2 from a bottom of the conical portion 104A of water bowl 104 through the bowl insert 112, the filter 114, the pump inlet 106B, the pump inlet screen 106C, the water pump 120, the pump outlet tube 122 and then forced through the vortex generating nozzle 126.

The water inlet 120 receives fresh water from an external water source, such as a water supply line or a water bottle. As such, the first water channel path P1 is designed to transport fresh water from the external water source directly into the water bowl 104. However, the present general inventive concept is not limited thereto.

In the present embodiment, the box-like portion 102B also houses a ToF sensor 128 for measuring water level without interference from the main bowl, if the pet is drinking. The ToF chamber 121 is filled by connecting tube 124 that has access to water in the water bowl 104 via opening 104E which provides water after filtering for the water level measurement by the ToF sensor 128 (see FIG. 9). In alternative embodiments, a mesh screen, such as a 50 micron screen, is inserted within the connecting tube 124 to collect contaminates within the water. However, the present general inventive concept is not limited thereto.

In the present embodiment, the ToF sensor 128 is mounted in the bowl control unit 140 to face downward into the ToF sonic weld cup 121. In a non-limiting embodiment, the ToF sensor 128 is a time of flight sensor capable of detecting water level difference of 1 mm. The Time of Flight sensor 128 is used to determine a water level in the water bowl 104 by measuring a water level in the ToF chamber 121.

In describing these external fresh water sources, it should be understood that these exemplary, non-limiting embodiments could be implemented in other specific details that correlate with the claimed method described herein, so that such specific details described herein are not considered as limiting to the scope of the present invention.

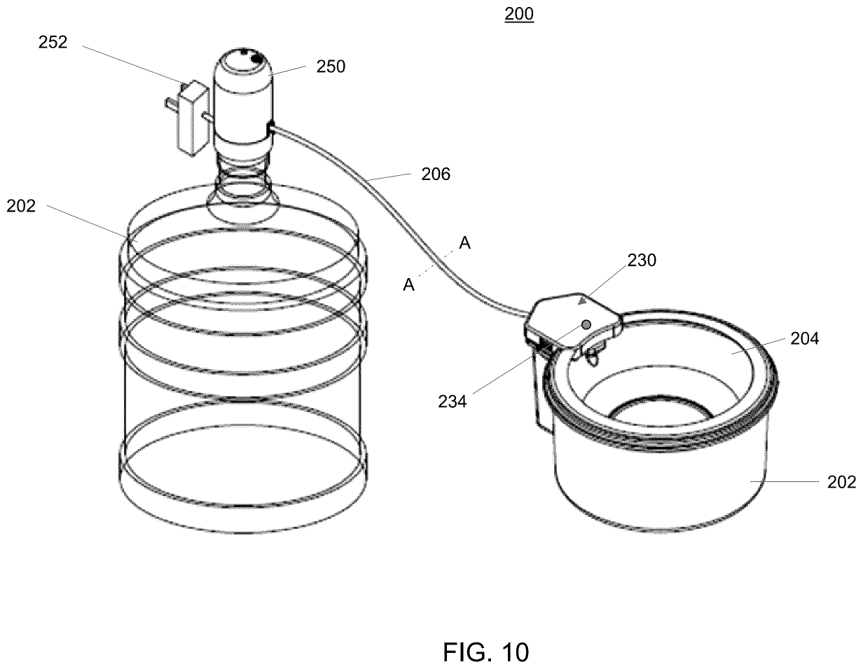

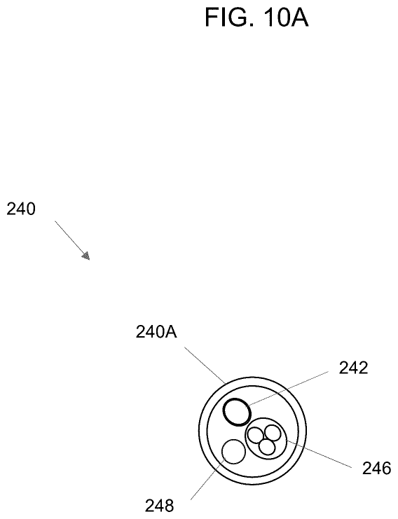

FIG. 10 shows a front perspective assembly view the automatic pet watering system 200 according another embodiment of the present general inventive concept and FIG. 10A shows a cross-sectional view of the integrated cable 240 illustrated in FIG. 10, along line A-A.

Referring to FIG. 10, in the present embodiment, the automatic pet water system 200 is coupled to an external water source 202, such as a five gallon jug.

That is, in the present embodiment, the automatic pet water system 200 is substantially similar to the previously described embodiment of the automatic pet water system 100, except the present embodiment further includes an external water source 202, a pump/controller assembly 250 coupled to the water bowl control unit 230 through an integrated cable 240.

Referring to FIG. 10, the automatic pet water system, designated generally as 200, is illustrated. In the present embodiment, the automatic pet watering system 200 is designed and configured to automatically and periodically remove all debris and contaminations from water stored in the water bowl 104. The automatic pet watering system 200 is also designed and configured to maintain the water in the water bowl 204 to a desired level, as defined by a user using water from an external water source 202.

The automatic pet watering system 200 according to the present general inventive concept includes a base housing 202 designed to support the water bowl 204, a filter system 210 (not illustrated), a bowl control unit 230 (e.g., a controller), and a water pump 220 (not illustrated) that automatically circulates water from the water bowl 204 through the filter system 210 and then back into the water bowl 204 using the pump/controller assembly 250 to receive water from the external water source 202 through the integrated cable 240.

Referring to FIG. 10A, the integrated cable 240 is configured to provide electrical signals and fluid communication between the pump/controller assembly 250 and the bowl control unit 230. That is, the integrated cable 240 encloses a power cable 242, a USB-C cable 246, and a water tubing 248 within an outer cover 240A. As such, the integrated cable 206 is configured to transmit power from the pump/controller assembly 250 to the bowl control unit 230 through the power cable 242.

In the present embodiment, the integrated cable 240 is configured to transmit and receive electrical and/or data signals from the pump/controller assembly 250 to the bowl control unit 230 through the USB-C cable 246 and, the integrated cable 206 is also configured to deliver fluid from the external water source 202 coupled to the pump/controller assembly 250 to the bowl control unit 230 through the water tubing 248. However, the present general inventive concept is not limited thereto.

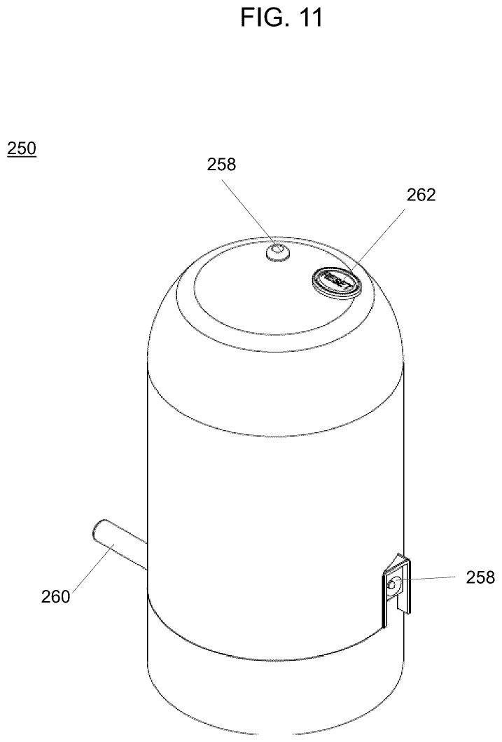

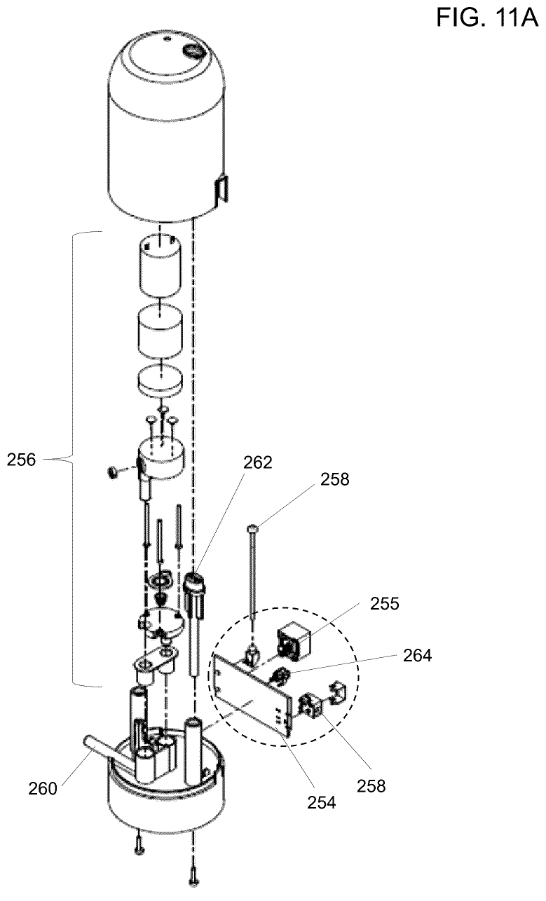

FIG. 11 shows a front perspective view the pump/controller assembly 250 illustrated in FIG. 10 according to an embodiment of the present general inventive concept and FIG. 11A shows an exploded assembly view of the pump/controller assembly 250 illustrated in FIG. 11.

Referring to FIGS. 11 and 11A, in the present embodiment, the pump/controller assembly 250 receives power from a power adaptor 252 electrically connected to an electrical outlet. For instance, the power adaptor 252 is connected to a 110V electrical outlet and transmits 12 Volts DC to the pump/controller assembly 250. The pump/controller assembly 250 then utilizes the power to operate a pump controller PCB 254 to instruct a pump 256 to pump water from the external water source 202 through the water tubing 248 into the water bowl 204.

In the present embodiment, the pump/controller assembly 250 has a power connector 259 that receives 12 Vdc from the power adaptor 252. A control unit 255 on the controller PCB 254 receives a pump signal from the bowl control unit on 230 to activate pump assembly 256 to pump water via the water outlet 260 to the water bowl assembly 204 through the integrated cable 240.

In the present embodiment, an annunciator 258 glows green when power is “ON”. A “RESET” push button 262 allows reset switch 264 to be activated for a reset. Some errors reset themselves, like, for example, if the water bowl assembly 204 is tilted beyond 15 degrees but returns back below 15 degrees.

In alternative embodiments, in contrast, other errors will need the user to hit “RESET” to correct the error and verify that no issues remain. One such error requiring “RESET” is “high water level detected”. However, the present general inventive concept is not limited thereto.

In the present embodiment, the pump/controller assembly 250 and the bowl control unit 230 may utilize various types of wireless communication, including Wi-Fi or Bluetooth™ for two-way communication with an optional application which can be downloaded by the user to a smartphone or mobile device. The user may then use the application to remotely communicate to the automatic pet watering system 200 according to the present general inventive concept to monitor a status of the automatic pet watering system 200, such as filter condition and/or water level. However, the present general inventive concept is not limited thereto. That is, in alternative embodiments, the automatic pet watering system 200 may operate with or without wireless communications sent to a wireless cloud network.

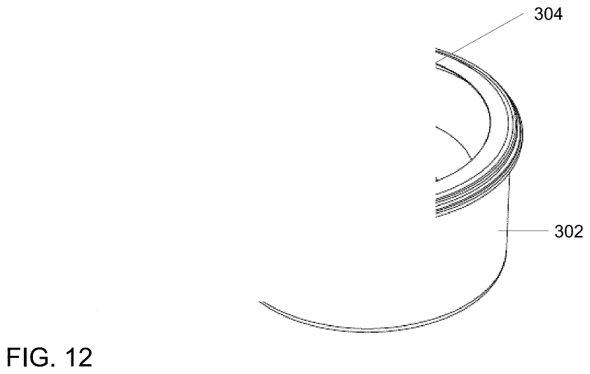

Referring to FIG. 12, in the present embodiment, the automatic pet water system 300 is substantially similar to the previously described embodiment of the automatic pet water system 100, except the present embodiment further includes a solenoid based control module 350 coupled to an external water source 370.

In the present embodiment, the external water source 370 is implemented using a pressurized water line 352, such as, for example, a water line configured with an adapter to connect to a household water faucet coupled to the solenoid based control module 350.

In the present embodiment, the solenoid-operated control module 350 receives command signals from a bowl control unit 330 in the water bowl assembly 304 to operate solenoid-operated water valves in the solenoid-operated control module 350. The solenoid-operated control module 350 is also referred to herein as a “wall unit” since attachment brackets 355 permit the solenoid-operated control module 350 to be mounted to a surface such as a wall.

Referring to FIG. 12, the automatic pet watering system, designated generally as 300, is illustrated. In the present embodiment, the automatic pet watering system 300 is designed and configured to automatically and periodically remove all debris and contaminations from water stored in the water bowl 304. The automatic pet watering system 300 is also designed and configured to maintain the water in the water bowl 304 to a desired level, as defined by a user using water from the external water source 370.

The automatic pet watering system 300 according to the present general inventive concept includes a base housing 302 designed to support the water bowl 304, a filter system 310 (not illustrated), a bowl control unit 330 (e.g., a controller), and a water pump 320 (not illustrated) that automatically circulates water from the water bowl 304 through the filter system 310 and then back into the water bowl 304 using the solenoid based control module 350 to receive water from the external water source 370 through the integrated cable 340.

Referring to FIG. 12, the integrated cable 340 is configured to provide electrical signals and fluid communication between the solenoid based control module 350 and the bowl control unit 330. That is, the integrated cable 340 encloses a power cable 342, a USB-C cable 346, and a water tubing 348 within an outer cover 340A. As such, the integrated cable 340 is configured to transmit power from the solenoid based control module 350 to the bowl control unit 330 through the power cable 340.

In the present embodiment, the integrated cable 340 is configured to transmit and receive electrical and/or data signals from the solenoid based control module 350 to the bowl control unit 330 through the USB-C cable 346 and, the integrated cable 340 is also configured to deliver fluid from the external water source 370 coupled to the solenoid based control module 350 to the bowl control unit 330 through the water tubing 348. However, the present general inventive concept is not limited thereto.

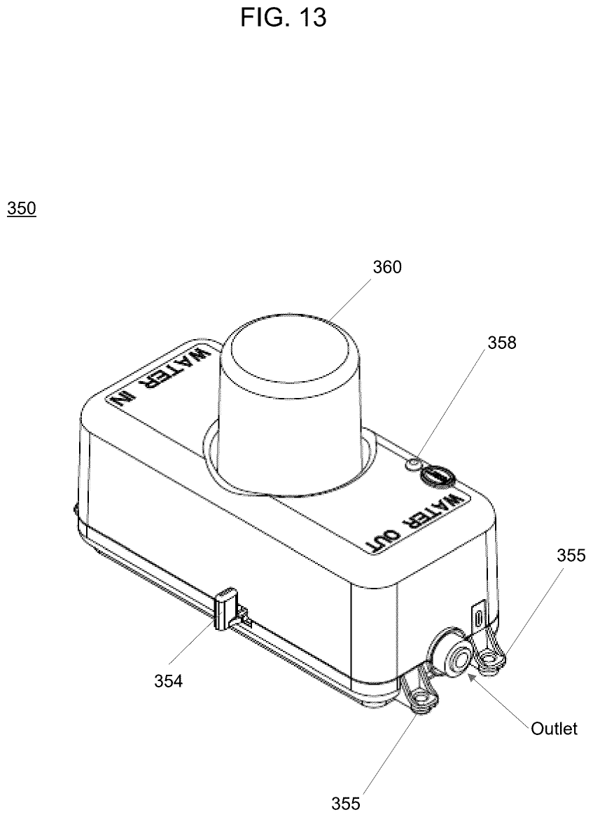

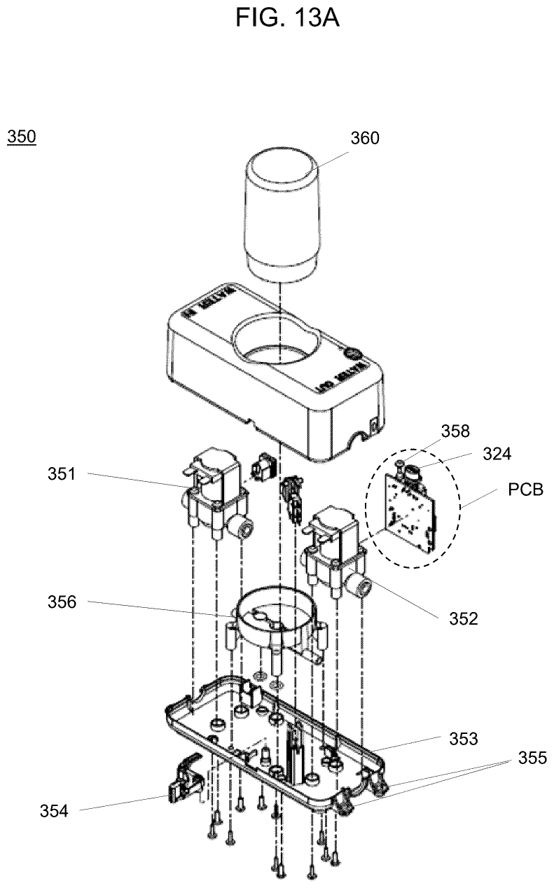

FIG. 13 shows a front perspective view of a solenoid assembly illustrated in FIG. 12 and FIG. 13A shows an exploded assembly view of the solenoid assembly illustrated in FIG. 13.

Referring to FIGS. 13 and 13A, the solenoid based control module 350 includes a replaceable charcoal filter cartridge 360 that filters incoming water from the external water source 370. If using the optional mobile application, the user may be notified to replace the filter cartridge 360 after approximately 100 gallons of water has been filtered through the filter cartridge 360 or after a period of 4 months has elapsed. However, the present invention is not limited thereto.

In the present embodiment, the solenoid based control module 350 includes a spring loaded lever 354 that releases the charcoal filter cartridge 360 from a housing bottom 353 of the solenoid based control module 350 and a filter cup 356 holds the charcoal filter cartridge 360 in place. In the present embodiment, the switch assembly 354 is switched when the charcoal filter cartridge 360 is removed, turning an LED 358 to a red color and pushing an error message to the mobile application, if used by the user.

In the present embodiment, the solenoid based control module 350 includes a first solenoid 351 referred to as “water in” solenoid 351 that is normally closed and a second solenoid 352 referred to as “water out” solenoid 352 that is normally closed. The first solenoid 351 includes a wire mesh screen inside. The second solenoid 352 has an orifice inside to reduce a water flow to one liter per minute. In addition, the “water out” solenoid 352 is protected from clogging over time by having charcoal filtered water it from the output of the filter cartridge 360.

In the present embodiment, the bowl control unit 330 controls an opening and closing of the first and second solenoids 351 and 352 to open, to allow water into the water bowl 304. The bowl control unit 330 may alternate every hour to open one solenoid and close the other solenoid and monitor or test whether any water enters the water bowl 304.

In exemplary embodiments, if water is detected rising in the water bowl 304 during this test, the bowl control unit 330 will notify the user of a solenoid stuck open error.

In alternative embodiments, the bowl control unit 330 will notify a third party (such as the Company) of a solenoid stuck open error only if the “water in” solenoid 351 is stuck open, since the “water out” solenoid 351 will last much longer (years) because it is used for filtered water. However, if both the “water in” solenoid 351 and the “water out” solenoids 351, 352 are detected open, the bowl control unit 330 will notify the user and the third party.

In the present embodiment, the first solenoid 351 is coupled in between the external water source 370 and the charcoal filter cartridge 360, and the second solenoid 352 is coupled in between the charcoal filter cartridge 360 and the water bowl 304.

In order to turn on and shut off the water supply to the water bowl 304 is as follows:

Initially, both the first and second solenoids 351, 352 are in a closed state, as they both are normally in the closed state.

Next, the bowl control unit 330 sends a supply water signal to the solenoid based control module 350 to supply water to the water bowl 304.

Next, the solenoid based control module 350 provides power to the first and second solenoids 351, 352 to activate to an open state, thereby allowing water to flow from the external water source 370 through the first solenoid 351, through the charcoal filter cartridge 360, through the second solenoid 352, and into the water bowl 304.

Next, the bowl control unit 330 sends a stop water signal to the solenoid based control module 350 when the water bowl 304 is full of water.

Next, the solenoid based control module 350 provides power to the first solenoid 351 to activate to a closed state, thereby stopping the water flow from the external water source 370 to the water bowl 304. After a period of approximately 90 seconds and it is determined that water has stopped flowing to the water bowl 304, the solenoid based control module 350 provides power to the second solenoid 352 to activate to a closed state.

The next time the bowl control unit 330 sends a stop water signal to the solenoid based control module 350 when the water bowl 304 is full of water, the solenoid based control module 350 provides power to the second solenoid 352 to activate to a closed state.

After a period of approximately 90 seconds and it is determined that water has stopped flowing to the water bowl 304, the solenoid based control module 350 provides power to the first solenoid 351 to activate to a closed state.

If it is determined that the water depth within the water bowl 304 increased with only the first or second solenoid 351, 352 in the closed state, a Water Out solenoid leaking is generated and sent to a wireless network.

Finally, at the end of the water shutoff process, when both the first and second solenoids 351, 352 are in the closed state, the second solenoid 352 is then activated to an open state and then immediately to a closed state after a period of 3 seconds in order to relieve pressure on the charcoal filter cartridge 360. This will allow a user to easily replace the charcoal filter cartridge 360, without any back pressure from the external water source 370.

In alternative embodiments, as previously discussed, the automatic pet watering system may further include a mobile application that provides a user with additional features and benefits. In general, this application is available in IOS and Android versions, and incorporates encrypted data for privacy. The user will pay an annual subscription fee using any of various possible payment methods, and this annual subscription must be paid annually, including auto renewal. Preferably the user will receive notifications that the subscription is about to automatically renew and notification via either text or email if payment has not been successful. User data associated with the app will be stored on the Cloud.

The application will incorporate a system setup mode in which the user will select either liters or gallons. A dashboard will show if “all systems are GO” and data pushed from the bowl controller to the Cloud and then to the app on a user's smart device. A green “light” will indicate that the system is functioning properly, and a red “light” would indicate an error has occurred. The user can tap the red “light” to see the error. Proper functioning of the system is indicated if, for example: water supply unit power is on, bowl power is on, correct systems check, bowl has water, and bowl is level on the floor.

The present general inventive concept will incorporate a reboot system notification that is pushed from the bowl control unit to the Cloud to the Application. For a reset, the user will press RESET on the wall unit and the system will power down and reset. Additionally, the user can use the application to reset the system to system defaults by pushing a reset command from the application to the Cloud and then to the bowl control unit. This command allows the application to reset all configurable values back to their default values.

In alternative embodiments, error messages that are pushed from the bowl control unit to the Cloud to the Application include, for example a failsafe mode, a missing bowl error, a bowl tilt error, a bowl filter error, a water blockage error, a failed to fill error, and a bowl overfill error. However, the present general inventive concept is not limited thereto.

In the present embodiment, the failsafe mode will monitor and report whether the device software was unresponsive, or whether a system component was able to be detected. The error message will indicate that the system has shut down and recommends the user to unplug the device for 10 seconds and plug back in afterwards.

In the present embodiment, the missing bowl error will monitor and report whether the system is unable to read the bowl's water level (e.g., water bowl is missing from the system).

In the present embodiment, the bowl tilt error will monitor and report whether the measured angle of the water bowl exceeded the bowl tilt threshold, for example 15 degrees.

In the present embodiment, the bowl filter error will monitor and report whether a Bowl Filter clog was detected or whether the filter needs to be cleaned or replaced by measuring an amperage draw on the water pump 320.

In the present embodiment, the water blockage error will monitor and report whether the system tried to fill the bowl over time but the water level did not exceed the water fill blockage threshold.

In the present embodiment, the failed to fill error will monitor and report whether the system tried to deactivate the solenoid to shut off water supply but water level has exceeded the Maximum Water Level Threshold, indicating the solenoid is stuck open.

In the present embodiment, the bowl overflow error will monitor and report whether the system detected the bowl has reached its maximum water level and has shut down.

Maintenance condition notifications pushed from the bowl controller to the Cloud to the app include, for example, a Waterline Charcoal Filter Replacement notification when the amount of water delivered to the bowl has exceeded the replacement threshold.

The user-defined-parameters feature can push changes from the app to change values in the firmware of the bowl controller. To implement this user-defined-parameter feature, the user must pay the annual subscription fee. The user-defined-parameter feature permits the user to change, for example: Waterline Height, to raise or lower the default water depth in the bowl. The options may include raise ¼ inch (or metric if selected), lower ¼ inch (or metric if selected), a default value is shown.

Th user may control a Bowl Flush Cycle in order to control how often per hour the user would like to flush the water bowl of debris. The options may include a value of times per hour, wherein the maximum times per hour is 6, and a default value is shown of 30 seconds per hour.

Although a few exemplary embodiments of the present general inventive concept have been illustrated and described, it will be appreciated by those skilled in the art that changes may be made in these exemplary embodiments and other embodiments may be made from the various features and relationships without departing from the principles and spirit of the general inventive concept, the scope of which is defined in the appended claims and their equivalents.

What is claimed is:

1. An automatic pet watering system, comprising:
a base housing configured to support various components of the automatic pet watering system;
a water bowl configured to fit into the base housing and configured to have a circular shape from a top view, a diameter of the circular shape decreasing so as to form a concave circular bowl surface for holding water, the concave circular bowl surface culminating in a circular opening forming a tube-shaped portion at a bottom of the main bowl, the concave circular bowl surface configured with a boss and opening near an upper edge of the concave circular bowl surface, the tube-shaped portion having first and second openings near a bottom edge of the tube-shaped portion;
a water pump configured for recirculating the water held in the main bowl, wherein the water pump is configured as connected a pump outlet tube having a distal end that projects through the opening of the boss at the upper edge of the concave circular bowl surface and is configured as connected to a pump inlet tube having a distal end affixed to the first opening at the bottom edge of the tube-shaped portion;
a bowl control unit configured to periodically operate the water pump on a predetermined schedule; and
a spray nozzle affixed to a distal end of the pump outlet tube and projecting through the boss at the upper edge of the concave circular bowl surface, the spray nozzle configured to project water from the pump outlet tube laterally from the pump outlet tube at an angle and orientation predetermined to cause a vortex effect in the water in the water bowl when the water pump is operating.

2. The automatic pet watering system of claim 1, further comprising a filter system fitted inside the tube-shaped portion at the bottom of the main bowl.

3. The automatic pet watering system of claim 2, wherein a top section of the filter system comprises
a bowl insert having a top surface shaped to form a bottom surface of the water bowl and having a bottom surface shaped with a snout and baffles that prevent floating debris from reentering the water bowl when the water pump is no longer operating to recirculate water in the main bowl.

4. The automatic pet watering system of claim 2, wherein the filter system comprises a debris storage section that holds debris sucked into the filter system as the water in the water bowl is recirculated.

5. The automatic pet watering system of claim 3 4, wherein the debris storage section comprises a cotton or charcoal/cotton filter to capture debris sucked through the filter system by the vortex formed by the water pump, the filter being supported by a mesh stainless steel filter cage.

6. The automatic pet watering system of claim 4, wherein a user can selectively access the debris storage section to expose and discard collected debris and exchange the cotton or charcoal/cotton filter with a new filter element.

7. The automatic pet watering system of claim 1, further comprising a splash guard ring affixed to a top edge of the main bowl.

8. The automatic pet watering system of claim 1, wherein the base housing is configured with a box-shaped portion with one end open to face an interior of the automatic pet watering system, the automatic pet watering system further comprising a lid portion configured to cover the box-shaped portion, the lid portion configured with a water dish input tube to be selectively attached to a water input tube structure connected to a water source providing fresh input water to the automatic pet watering system, wherein the water input tube structure comprises:
a water tube for carrying water from the water source to the automatic pet watering system;
a power line to provide electrical power to the recirculating motor and pump controller in the automatic pet watering system; and
a signal line to permit control signals between the pump control unit bowl controller in the automatic pet watering system and a controller located at the water source providing fresh water to the automatic pet watering system, and
wherein the water tube, power line, and signal line are protected from damage by pets by being enclosed in a stainless steel braiding.

9. The automatic pet watering system of claim 6 8, wherein the power line provides 12 VDC power to the water pump used to recirculate water in the main bowl.

10. The automatic pet watering system of claim 6 8, wherein the power line and signal line comprise a USB standard connector cable.

11. The automatic pet watering system of claim 6B 10, wherein the signal line in the USB standard connector cable provides data for an application that is optionally associated with the automatic pet watering system for providing a user with information related to the automatic pet watering system.

12. The automatic pet watering system of claim 6B 11, wherein the application can be selectively used by a user to remotely change any of a predetermined system setting values.

13. The automatic pet watering system of claim 6, wherein the lid portion covering the box-shaped portion is configured with at least one LED controlled by the pump control unit in the automatic pet watering system to indicate to a user any of the following a plurality of advisory conditions related to the automatic pet watering system: (listing of warnings available related to the system).

14. The automatic pet watering system of claim 6, further comprising a sensor that senses a level of water in the water bowl and provides water level information to the pump bowl controller, the pump bowl controller transmitting a control signal to a water source providing fresh water to the automatic pet watering system when the pump bowl controller determines that the water level has fallen below a predetermined amount.

15. The automatic pet watering system of claim 8 14, wherein the sensor that senses the water level comprises a Time of Flight (ToF) sensor.

16. The automatic pet watering system of claim 8A 15, wherein the ToF sensor comprises one of an infrared sensor and a laser sensor.

17. The automatic pet watering system of claim 6, the system further comprising a solenoid-based fresh water module configured to be connected to a pressurized water source and configured with a solenoid controller to control one or more solenoids in the solenoid-based fresh water module, the solenoid-based fresh water module configured with an output connected to the water input tube structure of the automatic pet watering system, the solenoid controller configured to receive signals on the signal line of the water input tube structure to control providing fresh water to the automatic pet watering system under control signals sent by the pump bowl controller in the automatic pet watering system.

18. The automatic pet watering system of claim 6, the system further comprising a pump-based fresh water module configured to be connected to a container storing fresh water available to be provided as fresh water to the automatic pet watering system upon demand from the pump bowl controller of the automatic pet watering system, the pump-based fresh water module configured with an output connected to the water input tube structure of the automatic pet watering system, the pump-based fresh water module configured with a fresh water pump and a fresh water pump controller, the fresh water pump controller configured to receive signals from the control unit in the water base on the signal line of the water input tube structure to control pumping fresh water to the automatic pet watering system under control signals sent by the pump bowl controller in the automatic pet watering system.

19. A pump-based fresh water module configured to be connected to a container of water to be supplied as fresh water to an automatic pet watering system, the pump-based fresh water module comprising:
a pump configured to pump water from the container of fresh water into an output water tube that provides fresh water to the automatic pet watering system;
a pump controller configured to control the pump that provides water from the container of fresh water to the automatic pet watering system, the pump controller configured to be under control signals from a control unit in the automatic pet watering system;
a power source that provides electrical power to the pump-based fresh water module; and
an output port configured to fit to a water tube structure to be connected between the automatic pet waterer system and the output port of the pump-based fresh water module, the water tube structure comprising:
a water tube for conducting fresh water from the container of fresh water to the automated pet waterer system;
a signal line for conducting control signals between the controller in the automatic pet watering system and the pump controller in the pump-based fresh water module; and
a power line to conduct electrical power to the automatic pet watering system via the pump-based fresh water module.

20. A solenoid-based fresh water module configured to be connected to a pressurized water line for providing fresh water to an automatic pet watering system, the solenoid-based fresh water module comprising:
at least one solenoid configured permit a flow of water from the pressurized water line into an output water tube that provides fresh water from the pressurized water line to the automatic pet watering system;
a solenoid controller configured to control the at least one solenoid, the solenoid controller configured to be under control signals from a controller in the automatic pet watering system;
a power source that provides electrical power to the solenoid-based fresh water module; and
an output port configured to fit to a water tube structure to be connected between the automatic pet waterer system and the output port of the solenoid-based fresh water module, the water tube structure comprising:
a water tube for conducting fresh water from the container of fresh water to the automatic pet watering system;
a signal line for conducting control signals between the controller in the automated pet waterer system and the pump controller in the solenoid-based fresh water module; and
a power line to conduct electrical power to the automatic pet watering system via the pump-based fresh water module.
